(19) United States
(12) Patent Application Publication
(10) Pub. No.: US 2005/0021391 A1
(43) Pub. Date: Jan. 27, 2005

(54) Employee performance reviewing method and system

(75) Inventors: Angel Lu, Taipei (TW); Ezoe Chang, Hsin-Tien City (TW)

Correspondence Address: SQUIRE, SANDERS & DEMPSEY L.L.P, 600 HANSEN WAY, PALO ALTO, CA, 94304-1043, US

(73) Assignee: VIA TECHNOLOGIES, INC., TAIPEI (TW)

(21) Appl. No.: 10/745,915

(22) Filed: Dec. 23, 2003

(30) Foreign Application Priority Data
Jul. 25, 2003 (TW) 92120365

(51) Int. Cl. G06F 17/60

(52) U.S. Cl. 705/11

(57) ABSTRACT

The present invention discloses an employee performance reviewing system, comprising a performance checking record, an application module for generating a message information and assigning a dispatching time depending on the performance checking record, and a message module for sending the message information to at least a receiver and receiving up-to-date messages from the receivers. The up-to-date message is generated according the message information and added into the performance checking record. By using of requesting the following-up checkers assessing the performances, the objective of procedure control can be reviewed. The present invention can further comprise an interface module and an encryption-decryption module to achieve the objective of the confidentiality and security of the data with cooperating a security mechanism.

### BACKGROUND OF THE INVENTION

1. Field of the Invention

The present invention relates to a network system program, and more particularly to the employee performance reviewing system performed by a network system program.

2. Description of the Prior Art

Traditionally, most employee performance reviewing models adopt paperwork, this means that the employee performance data and the director granting are handled with paperwork. It often takes a lot of time and is difficult to track the rate of progress of all the employees reviewed. Meanwhile, problems of losing data and omitting content remain a constant issue. For example, previously all the performance data of the employee to be reviewed would have to be individually collected. At this time, there are some unavoidable problems such as not informing employees, omitting data, not delivering data or delivering data late due to the employees at remote location and so on. Meanwhile, the confidentiality and security of the performance data may be in doubt. Moreover, when the director reviews the employee being reviewed, the reviewing process may be reviewed class by class and pass through many directors in the process. Meanwhile, the data probably needs to be sent to other divisions and even to other companies for review. The process of the performance review is difficult to control. The director may not know whether the reviewed data has arrived or not. Furthermore, a high cost manpower is needed to constantly track the rate of the reviewing progress and problems exist in the loss of paper data. Thus, the reviewed data must be placed into files, and finally all employees or directors being reviewed must be informed in regards to the last reviewing result. The data is stored into files in the paper form, and all the paper data needs to be stored in classification. Then, it is difficult to statistically analyze this data and a lot of manpower and time is needed to accomplish the task. Besides, there is another way to filing data into digital form, and it also needs much manpower and time. At least this way is convenient to statistically analyze reviewing data, but it also probably has the confidential problem.

In summary of the above mentioned, the traditional reviewing model in the paper form has many drawbacks like in controlling the difficulty of time, the lack of confidentiality and the control of data content, the wasting of manpower, and finally its not easy to statistically analyze. Therefore, a new system or process is needed to solve the above questions.

### SUMMARY OF THE INVENTION

The paperwork has questions for having not enough time and confidentiality, thereby its one objective of the present invention to provide a system for controlling procedure automatically and handling data individually.

It is another objective of the present invention to use a network system directly to proceed with a performance reviewing operating procedure. Time and space will not be limitation, and records can easily be kept, which will be a benefit for analyzing data with a computer and achieving no paper used.

According to above purposes, the present invention supplies a kind of individual work to ensure data security and confidentiality.

In order to achieve above purposes, the present invention supplies an employee performance reviewing method. The method comprises beginning a performance review of an employee by using a performance reviewing system for inputting on line. The system receives at least the performance data inputted by a reviewed employee. The performance data is added to a performance checking record of the employee performance reviewing system. The system receives at least a director review inputted by a director corresponding to the reviewed employee. The director inputs the director review in reference to the performance checking record and the director review is added to the performance checking record. The system processes the performance data and the director review to generate a performance reviewing result according to the performance checking record. The system ends the performance review and sends the results to the reviewed employee and the director. The present invention further includes a statistic analysis step to statistically analyze the performance data and the directors review process.

Meanwhile, the present invention also discloses an employee performance reviewing system. It comprises a performance checking record, an application module configured for generating a message information and a dispatching time of the message information according to the performance checking record, and a message module configured for, within the dispatching time, transmitting the message information to at least a receiver and accepting a up-to-date message from the receiver. The up-to-date message is generated according to the message information and added into the performance checking record through the application module. By using of requesting the following-up checkers assessing the performances, the objective of procedure control can be reviewed. The present invention can further include an interface module and an encryption-decryption module to achieve the objective of confidentiality and security of the data while cooperating with a security mechanism.

Besides, the present invention describes these characters and advantages as below, and combines with claims.

### BRIEF DESCRIPTION OF THE DRAWINGS

The present invention can be best understood through the following description and accompanying drawings wherein:

FIG. 1 is a schematic flow chart of the embodiment of the present invention.

FIG. 2 is a schematic systemic diagram of the embodiment of the present invention.

FIG. 3 is another schematic systemic diagram of the embodiment of the present invention.

### DESCRIPTION OF THE PREFERRED EMBODIMENT

Some embodiments of the present invention have detailed descriptions below. However, except for the detailed descriptions, the present invention can have a broad use in other embodiments, and the scope of the present invention can not be defined by this preferred embodiment, but by the appended claims.

Furthermore, in order to supply a more clear description and more understanding of the present invention, irrelative detailed portions are not completely drawn. And in the present invention disclosure content, this word “one” is regard as comprising single or plurality, contrary, any mentioned plurality shall also properly comprise single.

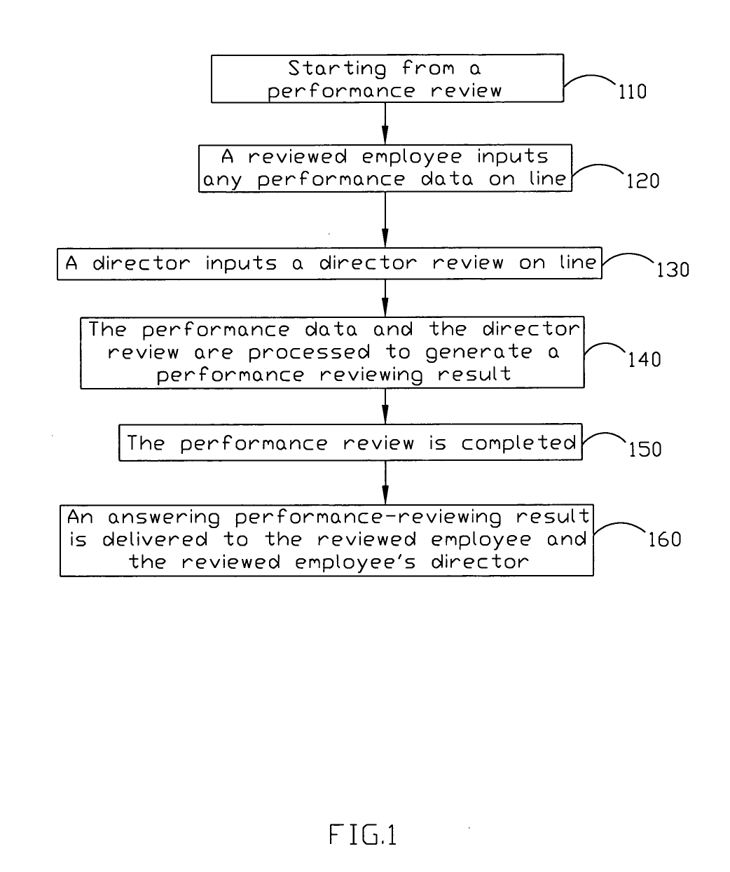

Referring to FIG. 1, the preferred embodiment of the present invention supplies an employee performance reviewing system to proceed the employee performance reviewing method, and the steps of the employee performance reviewing method starting from a performance review (step 110). A reviewed employee inputs any performance data on line (step 120), while a director inputs a director review on line (step 130). The performance data and the director review are processed to generate a performance reviewing result (step 140). The performance review is completed (step 150) and then an answering performance-reviewing result is delivered to the reviewed employee and the reviewed employee's director (step 160).

In the present invention, the performance data at least includes a work plan for first half of a year, an employee's self-review of performance, and a work plan for second half of the year. The performance data is stored as a performance checking record. The reviewed employee's director makes out one director review in accordance with the performance checking record, and the director review is also added into the corresponding performance checking record. The reviewed employee's director can be more than one, example for many directors in the same class or directly director in different class and a higher-class director. When making out one director's review, each director can read and refer to other director reviews existed in the corresponding performance checking record. At the same time, the performance data and the corresponding director review are processed so as to provide current contents under the requirement. Meanwhile, it achieves the objective of the procedure control, and summarizes all director reviews of all directors of the reviewed employee to produce a performance reviewing result.

When one reviewed employee or related one or more directors fail to complete the corresponding performance data or directors review, a manager can be authorized to input these data. The manager is only responsible to key in the data based on the manuscript contents generated or submitted by the performance contents and director review. The manager can be authorized to modify the up-to-date message. Furthermore, the performance data and director review are done within the time from the beginning to the ending of the employee performance review, and after the completion of the employee performance review, one the result is delivered to the corresponding reviewed employee and the reviewed employee's director, individually. Besides, all of the performance data, director reviews, and performance reviewing results can be processed with statistical analysis to acquire reference data about all employees of the company.

In order to directly execute the employee performance reviewing on the network, a system is used to provide the reviewed employees and directors for a user interface to input the performance data and director reviews for the performance checking record. The performance checking record also includes a director's reviewing result that can be sent to the corresponding reviewed employee and director after the completion of the employee performance review. Furthermore, through an application module, the contents of the performance reviewing system can be modified or added into the performance checking records at the request of the user interface. Meanwhile, the user interface can request the reviewed employee and director to input or submit data and review requests. The requested review can be transmitted through a message module, and meanwhile, the message module can transmit up-to-date messages of review requesting back to the application module. Furthermore, cooperating with a security mechanism and an encryption-decryption module, the present invention can make all procedures individually and ensure the confidentiality of the data, as well as the control of the time and progress.

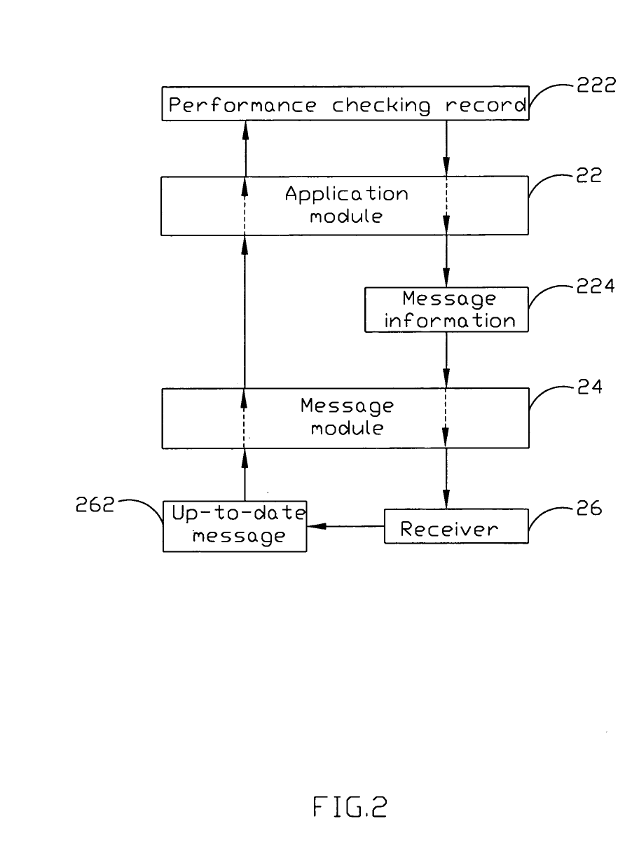

Accordingly, another preferred embodiment of the present invention is a performance reviewing system, as shown in FIG. 2. The performance reviewing system includes an application module 22 and a message module 24. The application module 22 manages a performance checking record 222. The application module 22 respectively produces a message information 224 and the dispatching time of the message information 224 according to the performance checking record 222. The message information 224 is transmitted to at least a receiver 26 at the dispatching time through the message module 24. The receiver 26 may input an up-to-date message 262 according to the message information 224. Then through the message module 24, the up-to-date message 262 is transmitted to add to the performance checking record 222 though the application module 22.

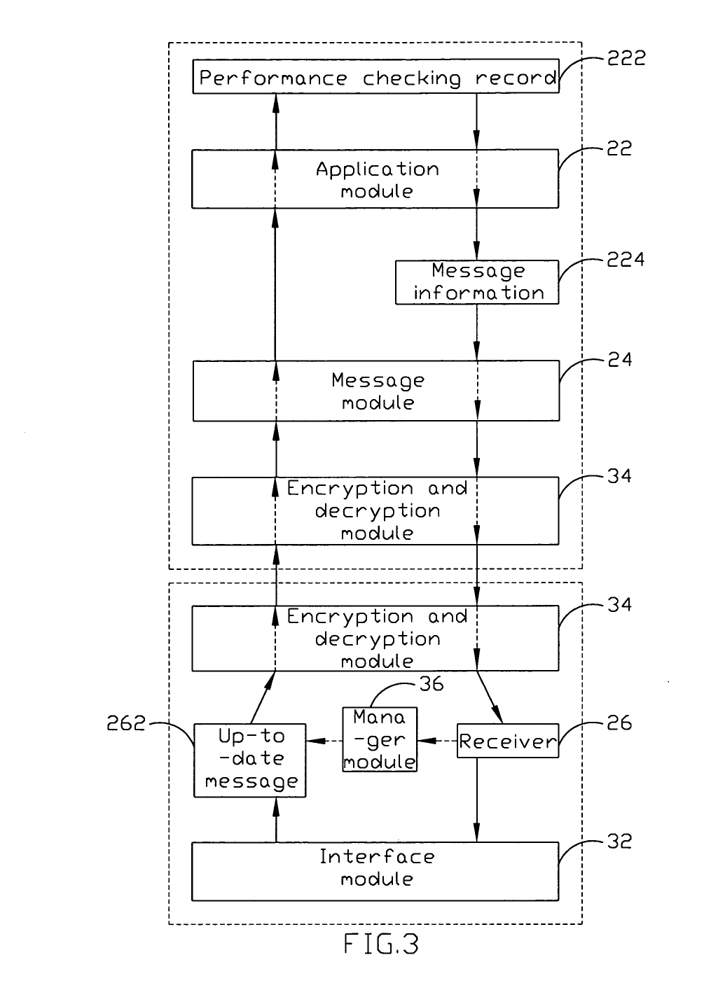

The contents of the message information 224 comprises a portion or all of the performance checking record 222 and data extended from the performance checking record 222. The extended data includes the receiver 26 and interface contents provided by the receiver 26 and so on. Alternatively, according to the contents existed on the user interface, a user can input an up-to-date message 262. Depicted in FIG. 3, a preferred embodiment of the present invention further has an interface module 32. The interface module 32 provides different users 26 with multitudes of different interfaces according interface contents, displays the related contents to the corresponding receiver 26 to input up-to-date message 262, and sends the up-to-date message 262 back to a message module 24 to add to the performance checking record 222 through the application module 22. Furthermore, through some interface content settings, the interface module 32 can restrict the contents that the receiver 26 can view. Therefore, there is a security mechanism to ensure the message information 224 to be read and the up-to-date message 262 to be generated by an authorized receiver 26. For example, such an authorized receiver 26 can view the message information 224 and input the up-to-date message 262 on the condition that an account and a password inputted through the user interface are matched and confirmed by the user interface. The account and password can previously be stored in the interface content or performance checking record 222.

Furthermore, there is further an encryption-decryption module 34 configured for ensuring the message information 224 and up-to-date message 262 viewed by an authorized receiver 26. For example, the message information 224 and up-to-date message 262 can be encrypted before dispatching or transmission, and decrypted after receiving. Furthermore, the message information 224 and up-to-date message 262 can be encrypted or decrypted on the confirmation condition of the receiver 26. Besides, there is further a manager module 36 configured for adding a manager replacing the receiver 26 to input up-to-date message 262 and modifying performance checking record (not shown in figure) with the application module. Accordingly, a modifying data is generated by the manager through the manager module, received by the message module, and added into the contents of the performance checking record through the application module. Furthermore, the application module further has a control function with which a notice can be sent to the receiver and director on the condition that the up-to-date message is not received before an approaching deadline. A finishing deadline is acquired when an application module generates message information.

In addition, when the receiver is a reviewed employee and the up-to-date message is an employee performance reviewing data, the up-to-date message is generated through inputting a work plan for first half of a year, a self-reviewed performance, and a work plan for second half of the year. The reviewed employee follows the steps for performance after the completion of the work plan for first half of a year. The work plan for second half of the year begins after the completion of the work plan for first half of a year.

In addition, the receiver can be more than one director. These directors review of the reviewed employee and produce director reviews, and all produced director reviews are added into performance checking records. Therefore, one director receives message information that has employee performance reviewing data and other directors' director reviews from the employee performance reviewing data and inputs another one director review according to the existing message information. However, such message information may include all of the performance checking record, but what one receiver can view, may be subjected to the interface contents. Therefore, after the generation of one up-to-date message, the application module can send one or many of the reviewed employee's director's message information to one or many corresponding directors and request director review. The above-mentioned procedures may be executed over and over again until one director is one of the most superior directors. Accordingly, once the most superior director completes the director review, employee performance reviewing data may be sent to the reviewed receiver and the corresponding directors.

Moreover, the preferred embodiment can be implemented through a client-server module. The above-mentioned performance checking records can be accessed from a database. Furthermore, the performance checking record also can include multitudes of sub-records stored in the database. Besides, the message information and up-to-date messages also can be accessed from the database. And the application module, message module and interface module may be integrated in a server.

Furthermore, the preferred embodiment can be implemented through a multi-layer module. The interface module can be implemented by an interface of web page for displaying the contents of the message information. Accordingly, the message module that can be implemented by a web page server and the application module that can be implemented by an application server may cooperate with a rear database to access the performance checking records.

Moreover, the preferred embodiment can be implemented by a message system. The message module can be implemented by an e-mail server. Moreover, the interface module can also be implemented by an e-mail client in whom the interface contents can display in a script language, such as HTML or XML. Accordingly, the performance checking record can be an electronic mail sent to the reviewed employee and the related directors. A sequential electronic mail, which may include a previously existed content, may be sent to the receivers and display a portion or all of the contents. Furthermore, the receivers can transmit up-to-date message with an electronic mail. The message module, application module and interface module also can be implemented by a web mail server that includes the web server and mail server.

Accordingly, the present invention can be implemented by database, web server, e-mail server, application server, or the composition of servers, so as to possess multitudes of functions, such as the management of the performance checking record, transmission of the up-to-date message, message information, and the control of the procedure, and so on. In the present invention, the procedure of employee performance review can be directly executed on the network without limitation on time or space.

Above said preferred embodiments are only used to illustrate the present invention, not intended to limit the scope thereof. Many modifications of the preferred embodiments can be made without departing from the spirit of the present invention. Therefore, the scope of the invention only is limited by the claims.

1. A method for reviewing employee performance, said method comprising:
beginning to review employee performance with an employee performance reviewing system for inputting on line;
receiving at least a performance data inputted by at least a reviewed employee, wherein said performance data is added to a performance checking record of said employee performance reviewing system;
receiving at least a director review inputted by at least a director corresponding to said reviewed employee, wherein said director inputs said director review in reference to said performance checking record and said director review is added to said performance checking record;
processing said performance data and said director review to generate a performance reviewing result, wherein said performance reviewing result is according to said performance checking record;
ending said review performance; and
sending said performance reviewing result to said reviewed employee and said director.

2. The method of claim 1, wherein said performance data comprises a work plan for first half of a year, an employee self-reviewed performance, and a work plan for second half of the year.

3. The method of claim 1, wherein said director inputs said director review in reference to an existed performance reviewing data and an existed director review inputted by other directors.

4. The method of claim 1, further comprising steps by processing said performance data, said director review and said performance reviewing result with a statistic analysis.

5. A system for reviewing employee performance, said system comprising:
a performance checking record;
an application module configured for generating a message information and a dispatching time of said message information according to said performance checking record; and
a message module configured for, within said dispatching time, transmitting said message information to at least a receiver and accepting an up-to-date message from said receiver, wherein said up-to-date message is generated according to said message information and added into said performance checking record through said application module.

6. The system of claim 5, wherein said message information comprises said performance checking record.

7. The system of claim 5, wherein said application module further adding an interface content to said message information according to said receiver and said performance checking record.

8. The system of claim 7, further comprising an interface module configured for providing said receiver with a user interface, wherein said user interface is generated in reference to said interface content, and wherein said user interface enables said receiver inputting said up-to-date message and transmitting said up-to-date message to said message module.

9. The system of claim 8, wherein said receiver only could view a portion of said message information through said user interface, and wherein said portion of said message information is subjected to said interface content.

10. The system of claim 8, wherein said user interface further comprises a security mechanism, and said security mechanism ensures said up-to-date message to be inputted by said receiver.

11. The system of claim 5, further comprising an encryption-decryption module ensures said message information and said up-to-date message only be viewed by said receiver.

12. The system of claim 5, wherein said receiver is a reviewed employee, and said up-to-date message is an employee performance reviewing data, and wherein said reviewed employee updates said up-to-date message generated steps comprising:
inputting a work plan for first half of a year for generating said work plan for first half of a year;
inputting a self-reviewed performance for generating an employee review, wherein said reviewed employee follows inputs said self-reviewed performance after said work plan for first half of a year inputs step finished; and
inputting a work plan for second half of the year for generating said reviewed employee's work plan for second half of the year, and said work plan for second half of the year begins to input steps after said work plan for first half of a year finishes inputting steps.

13. The system of claim 12, wherein said receiver is a director, and said up-to-date data results from said director review, and wherein said director review is finished according to said employee performance reviewing message.

14. The system of claim 13, wherein said receiver is a superior director, and said up-to-date data results from said director review, and wherein said director review result is according to all of said director reviews inputted by other said directors among said performance checking record.

15. The system of claim 14, wherein said receiver refers to said reviewed employee and all said directors of said reviewed director, and said message information shows result made by said director, and wherein said dispatching time comes after said performance reviewing result.

16. The system of claim 5, wherein said interface module is a web page interface.

17. The system of claim 5, wherein said performance checking record is stored by a database.

18. The system of claim 5, further comprising a manager module, wherein said manager module providing a manager instead of said receiver to produce said up-to-date message.

19. The system of claim 18, wherein said manager module further providing said manager a function to modify said performance record, and wherein said manager inputs a modified data with said manager module, said modified data is received by said message module, and said performance record contents is changed by said application module.

20. The system of claim 18, wherein further with a control function, said application module sends a notice to said receiver and said director while said application module has not yet received any said up-to-date message before an approaching deadline.
